(19) United States
(12) Patent Application Publication
(10) Pub. No.: US 2026/0012637 A1
(43) Pub. Date: Jan. 8, 2026

(54) PRELIMINARY INTRA-PREDICTION MODE DETERMINATION METHOD AND INTRA-PREDICTION CIRCUIT FOR VIDEO CODING

(71) Applicant: Sigmastar Technology Ltd., Xiamen (CN)

(72) Inventors: Wei Min Zeng, Xiamen (CN); Cheng Hung Tsai, Hsinchu County (TW)

(21) Appl. No.: 19/238,151

(22) Filed: Jun. 13, 2025

(30) Foreign Application Priority Data
Jul. 5, 2024 (CN) 202410902846.8

(51) Int. Cl. H04N 19/593; H04N 19/70

(52) U.S. Cl. CPC H04N 19/593; H04N 19/70

(57) ABSTRACT

A preliminary intra-prediction mode determination method for video coding is provided. The method is executed in a prediction circuit and configured to determine a preliminary prediction mode of a to-be-predicted block. The method includes the following steps: calculating a first prediction angle of the to-be-predicted block; determining whether the to-be-predicted block is a noise block; and executing a non-angle mode decision when the to-be-predicted block is the noise block, or when the to-be-predicted block is not the noise block and the first prediction angle is not greater than a preset angle. The non-angle mode decision determines the preliminary prediction mode according to whether the to-be-predicted block is the noise block and the comparison result between the first prediction angle and the preset angle.

This application claims the benefit of China application Serial No. CN202410902846.8, filed on Jul. 5, 2024, the subject matter of which is incorporated herein by reference.

### BACKGROUND OF THE INVENTION

### 1. Field of the Invention

The present invention generally relates to video coding, and more particularly, to a preliminary intra-prediction mode determination method and an intra-prediction circuit.

### 2. Description of Related Art

The currently common video coding and decoding methods include the following three: H.264 (i.e., the MPEG-4 Part 10, Advanced Video Coding, referred to as MPEG-4 AVC), H.265 (i.e., the High Efficiency Video Coding, referred to as HEVC), and AV1 (i.e., the Alliance for Open Media, AOMedia Video 1). Because these three methods have their respective specifications, it is not easy to integrate any two or all three of them into a single video codec, resulting in an increase in the cost of the end product.

### SUMMARY OF THE INVENTION

In view of the issues of the prior art, an object of the present invention is to provide preliminary intra-prediction mode determination method and an intra-prediction circuit for video coding, so as to make an improvement to the prior art.

According to one aspect of the present invention, A preliminary intra-prediction mode determination method for video coding is provided. The preliminary intra-prediction mode determination method is executed in a prediction circuit for determining a preliminary prediction mode of a to-be-predicted block and includes the following steps: calculating a first prediction angle of the to-be-predicted block; determining whether the to-be-predicted block is a noise block; and executing a non-angle mode decision when the to-be-predicted block is the noise block, or when the to-be-predicted block is not the noise block and the first prediction angle is not greater than a preset angle. The non-angle mode decision determines the preliminary prediction mode according to whether the to-be-predicted block is the noise block and a comparison result between the first prediction angle and the preset angle.

According to another aspect of the present invention, an intra-prediction circuit is provided. The intra-prediction circuit is configured to perform an intra-prediction operation on a to-be-predicted block to generate an intra-prediction image. The intra-prediction circuit includes: an MPEG-4 Part 10 Advanced Video Coding (H.264) mode control circuit configured to output a plurality of reconstructed pixels and a preliminary prediction mode corresponding to the to-be-predicted block according to a start signal of the to-be-predicted block; a shared control circuit coupled to the H.264 mode control circuit and configured to output the plurality of reconstructed pixels and the preliminary prediction mode corresponding to the to-be-predicted block according to the start signal; and at least one prediction circuit coupled to the H.264 mode control circuit and the shared control circuit and configured to generate a plurality of predicted values based on the plurality of reconstructed pixels, and determine a part of the intra-prediction image from the plurality of predicted values according to the preliminary prediction mode. The start signal of the to-be-predicted block indicates the start of the to-be-predicted block.

The technical means embodied in the embodiments of the present invention can solve at least one of the problems of the prior art. Therefore, compared to the prior art, the present invention can save circuit area, cost, and power.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of the video encoder according to an embodiment of the present invention.

FIG. 2 is a flowchart of the prediction angle determination method according to an embodiment of the present invention.

FIG. 3 is a schematic diagram for calculating the intensities of the R angles of the pixel according to an embodiment of the present invention.

FIG. 4 is a flowchart for determining whether the to-be-predicted block is a noise block according to an embodiment of the present invention.

FIG. 5 is a flowchart of the angle preselection circuit determining the preliminary prediction mode according to an embodiment of the present invention.

FIGS. 6A to 6B are flowcharts of the non-angle mode decision according to an embodiment of the present invention.

FIG. 7A is a schematic diagram of the angle mode decision according to an embodiment of the present invention.

FIG. 7B is a flowchart of the angle mode decision according to an embodiment of the present invention.

FIG. 8 is a functional block diagram of the intra-prediction circuit according to an embodiment of the present invention.

FIG. 9 is a functional block diagram of the H.264 mode control circuit according to an embodiment of the present invention.

FIG. 10 is a schematic diagram of the reconstructed pixels corresponding to multiple to-be-predicted blocks in the present invention.

FIG. 11 is a functional block diagram of the shared control circuit according to an embodiment of the present invention.

FIG. 12 is a schematic diagram of the buffer circuit according to an embodiment of the present invention.

FIG. 13 is a schematic diagram of the above-left reconstructed pixels of the present invention.

FIG. 14 is a functional block diagram of the prediction circuit according to an embodiment of the present invention.

FIG. 15 is a functional block diagram of the prediction circuit according to another embodiment of the present invention.

FIG. 16 is a functional block diagram of the angle mode prediction circuit according to an embodiment of the present invention.

FIG. 17 is a functional block diagram of the prediction circuit according to another embodiment of the present invention.

FIG. 18 is a functional block diagram of the angle mode prediction circuit according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a preliminary intra-prediction mode determination method and an intra-prediction circuit for video coding. On account of that some or all elements of the intra-prediction circuit could be known, the detail of such elements is omitted provided that such detail has little to do with the features of this disclosure, and that this omission nowhere dissatisfies the specification and enablement requirements. Some or all of the processes of the preliminary intra-prediction mode determination method may be implemented by software and/or firmware and can be performed by the intra-prediction circuit or its equivalent. A person having ordinary skill in the art can choose components or steps equivalent to those described in this specification to carry out the present invention, which means that the scope of this invention is not limited to the embodiments in the specification.

In the following discussion, a block of N pixels by N pixels is referred to as an N*N block.

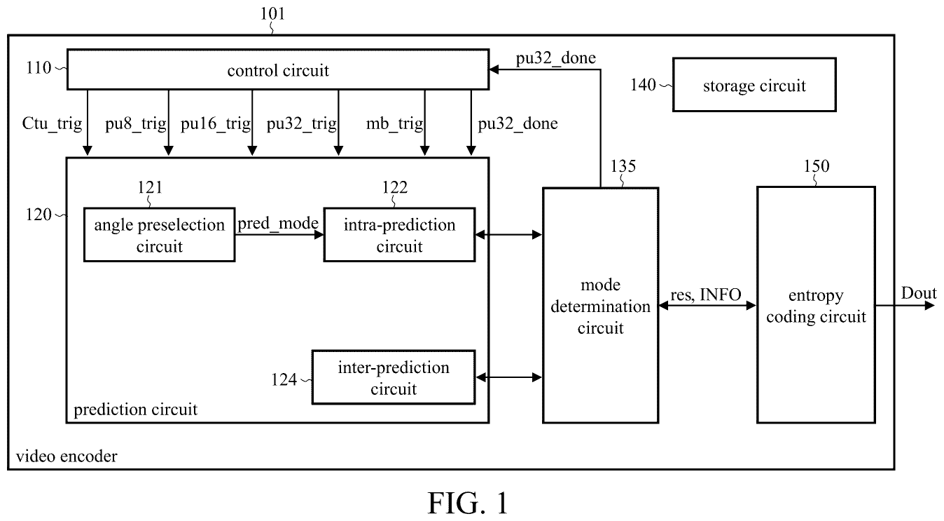

Reference is made to FIG. 1, which is a functional block diagram of a video encoder according to an embodiment of the present invention. The video encoder 101 includes a control circuit 110, a prediction circuit 120, a mode determination circuit 135, a storage circuit 140, and an entropy coding circuit 150. The prediction circuit 120 includes an angle preselection circuit 121, an intra-prediction circuit 122, and an inter-prediction circuit 124.

The control circuit 110 controls the coding process of the video encoder 101 through the start signal Ctu_trig, the start signal pu8_trig, the start signal pu16_trig, the start signal pu32_trig, and the start signal mb_trig. The start signal Ctu_trig indicates the start of a coding block (i.e., a block to be predicted by the prediction circuit 120). The prediction circuit 120 performs pre-operations (including, but not limited to, resetting parameters and/or registers) for coding a coding block based on the start signal Ctu_trig. The start signal mb_trig indicates the start of a macro block (16*16) in the H.264 mode (the macro block is a type of coding block). The start signal pu32_trig indicates the start of a 32*32 coding block in the H.265 mode and the AV1 mode. The start signal pu16_trig indicates the start of a 16*16 coding block in the H.265 mode and the AV1 mode. The start signal pu8_trig indicates the start of an 8*8 coding block in the H.264 mode, the H.265 mode, and the AV1 mode.

The intra-prediction circuit 122 performs intra-prediction on a to-be-predicted block based on a preliminary prediction mode pred_mode generated by the angle preselection circuit 121 to generate an intra-prediction image. The inter-prediction circuit 124 performs inter-prediction on a to-be-predicted block to generate an inter-prediction image. The inter-prediction circuit 124 further generates prediction information based on motion estimation.

The mode determination circuit 135 performs the following operations: subtracting the original image from the prediction image (the intra-prediction image or inter-prediction image) to generate the image difference; performing the transformation operation and the quantization operation on the image difference to obtain the residual res; and performing the inverse quantization operation and the inverse transformation operation on the residual res to obtain an intermediate result, then adding the intermediate result to the prediction image to generate a reconstructed image. A reconstructed image contains multiple reconstructed pixels. The mode determination circuit 135 also performs a full rate-distortion optimization (RDO) operation based on the intermediate results and a rate table to generate an intermediate data INFO. The intermediate data INFO includes, but is not limited to, the block coding method of the image blocks, and the block coding method is used to determine how to divide the image blocks (i.e., to decide whether to code with larger blocks or smaller blocks), as well as whether to use an intra-prediction image or an inter-prediction image for coding.

The entropy coding circuit 150 is coupled to the mode determination circuit 135 and is configured to perform entropy coding based on the residual res and the intermediate data INFO to obtain the output data Dout (e.g., bitstream).

The method of generating the intermediate data INFO and the entropy coding operation are well known to people having ordinary skill in the art, so further elaboration is omitted for brevity.

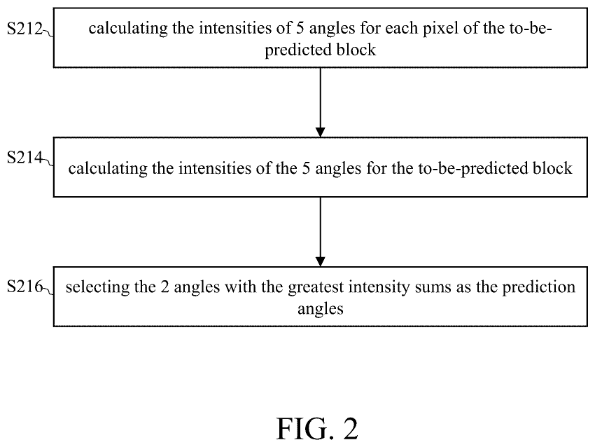

Reference is made to FIG. 2, which is a flowchart of the prediction angle determination method according to an embodiment of the present invention. The method includes the following steps.

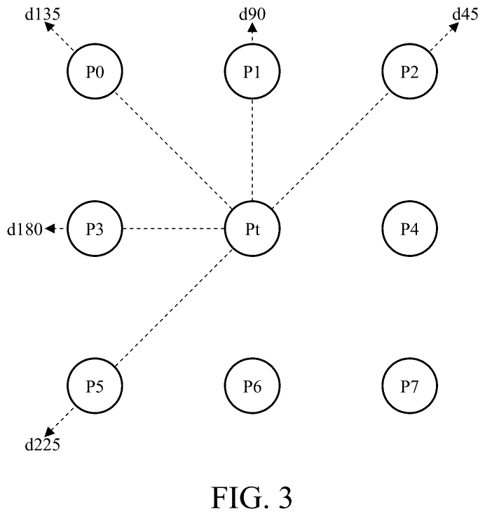

Step S212: The angle preselection circuit 121 calculates the intensities of R angles for each pixel of the to-be-predicted block (R is an integer greater than or equal to 2). The following assumes that R=5 and the 5 angles are d45, d90, d135, d180, and d225 (representing 45 degrees, 90 degrees, 135 degrees, 180 degrees, and 225 degrees, respectively), and the intensities corresponding to the 5 angles are s45, s90, s135, s180, and s225, respectively. The details of this step will be elaborated below with reference to FIG. 3.

Step S214: The angle preselection circuit 121 accumulates the intensities of the 5 angles for the to-be-predicted block. More specifically, if the to-be-predicted block has M pixels, the angle preselection circuit 121 sums the M intensities corresponding to each of the 5 angles, ultimately obtaining 5 intensity sums corresponding respectively to the 5 angles.

Step S216: Selecting the 2 angles with the greatest intensity sums as the prediction angles (the first prediction angle do and the second prediction angle d1, where the intensity sum of the first prediction angle do is greater than or equal to the intensity sum of the second prediction angle d1). For example, if the 5 intensity sums are s90, s180, s135, s45, and s225 in descending order, then the angle preselection circuit 121 selects d90 and d180 as the first prediction angle do and the second prediction angle d1, respectively (if the 2 largest intensity sums are equal, then the result is the same regardless of which one is selected as do).

Reference is made to FIG. 3, which is a schematic diagram of the intensity calculation for the 5 angles of a pixel according to an embodiment of the present invention. Pt is the current pixel, P0 to P7 are the 8 pixels surrounding the current pixel Pt. The method of calculating the intensities of the 5 angles (s45, s90, s135, s180, and s225) is shown in the following equations (1) to (10) (where the pp0 to the pp7 are the luminance values of the pixels P0 to P7, respectively).

$$s 45 p = \vert ( pp 1 + 2 \times pp 2 + pp 4 ) - ( pp 3 + 2 \times pp 5 + pp 6 ) \vert \qquad ( 1 )$$

$$s 90 p = \vert ( pp 0 + 2 \times pp 1 + pp 2 ) - ( pp 5 + 2 \times pp 6 + pp 7 ) \vert \qquad ( 2 )$$

$$s 135 p = \vert ( pp 3 + 2 \times pp 0 + pp 1 ) - ( pp 6 + 2 \times pp 7 + pp 4 ) \vert \qquad ( 3 )$$

$$s 180 p = \vert ( pp 0 + 2 \times pp 3 + pp 5 ) - ( pp 2 + 2 \times pp 4 + pp 7 ) \vert \qquad ( 4 )$$

$$s\_max = max \{ s 45 p , s 90 p , s 135 p , s 180 p \} \qquad ( 5 )$$

$$s 45 = s\_max - s 45 p \qquad ( 6 )$$

$$s 90 = s\_max - s 90 p \qquad ( 7 )$$

$$s 135 = s\_max - s 135 p \qquad ( 8 )$$

$$s 180 = s\_max - s 180 p \qquad ( 9 )$$

$$s 225 = s 45 \qquad ( 10 )$$

The angle d45 and the angle d225 are actually the same angle, and the intensity of both is the same (Equation (10)). Equations (1) to (10) involve gradient calculation and the direction intensity calculation. In some embodiments, the gradient calculation and the direction intensity calculation can respectively use the Sobel operator and the maximum gradient difference method. However, the present invention is not limited to these operators and methods. For example, it is also possible to take the Sobel operator value in the direction that differs by 90 degrees from its own angle as its own intensity.

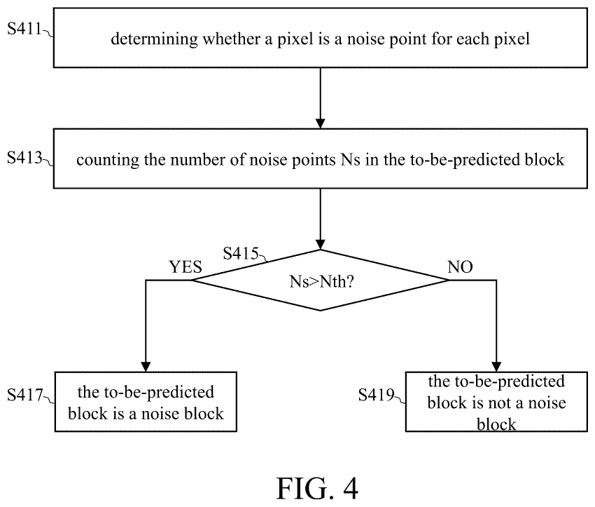

Reference is made to FIG. 4, which is a flowchart for determining whether a to-be-predicted block is a noise block according to an embodiment of the present invention. The flowchart includes the following steps.

Step S411: The angle preselection circuit 121 determines whether a pixel is a noise point for each pixel. The method of determining whether a pixel is a noise point is well known to people having ordinary skill in the art, so further elaboration is omitted for brevity.

Step S413: The angle preselection circuit 121 counts the number of noise points Ns in the to-be-predicted block.

Step S415: The angle preselection circuit 121 determines whether the number of noise points Ns is greater than a threshold value Nth. For example, the threshold value Nth may be 20% of the number of pixels in the to-be-predicted block. If the result of step S415 is YES, the angle preselection circuit 121 determines that the to-be-predicted block is a noise block (step S417); otherwise, the angle preselection circuit 121 determines that the to-be-predicted block is not a noise block (step S419).

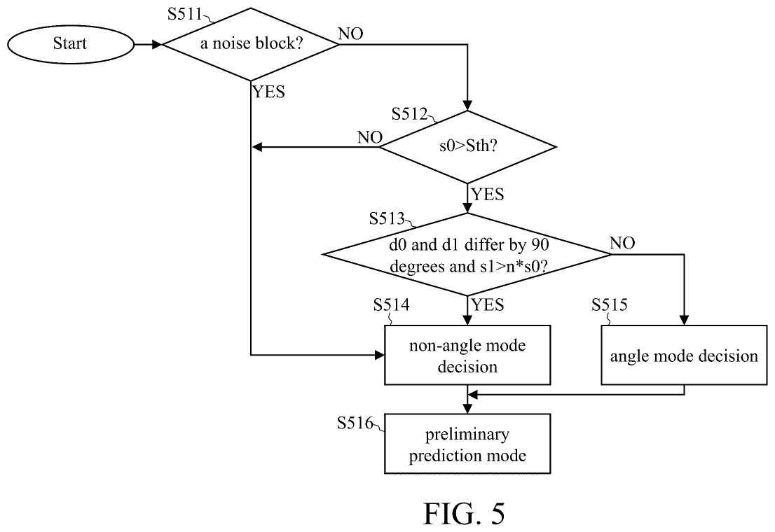

Reference is made to FIG. 5, which is a flowchart of the angle preselection circuit 121 determining the preliminary prediction mode pred_mode according to an embodiment of the present invention. The flowchart includes the following steps.

Step S511: The angle preselection circuit 121 determines whether the to-be-predicted block is a noise block (please refer to the flowchart in FIG. 4). If the to-be-predicted block is a noise block, then the flow proceeds to step S514; otherwise, the flow proceeds to step S512.

Step S512: The angle preselection circuit 121 determines whether the intensity s0 of the first prediction angle do is greater than a preset intensity Sth. In some embodiments (which are intended to illustrate the invention by way of example, rather than to limit the scope of the claimed invention), the preset intensity Sth is 40. If the intensity s0 of the first prediction angle do is greater than the preset intensity Sth, then the flow proceeds to step S513; otherwise, the flow proceeds to step S514.

Step S513: The angle preselection circuit 121 determines whether the first prediction angle do and the second prediction angle d1 differ by 90 degrees, and whether the second intensity s1 is greater than n times the first intensity s0 (0<n<1). The first intensity s0 and the second intensity s1 are intensities corresponding to the first prediction angle do and the second prediction angle d1, respectively, and the first intensity s0 is greater than the second intensity s1. In some embodiments, n may be 0.3. When the second intensity s1 is not greater than n times the first intensity s0, it indicates that the second intensity s1 is significantly smaller than the first intensity s0. In other words, even if the first prediction angle do and the second prediction angle d1 differ by 90 degrees, the angle preselection circuit 121 makes a decision based on the angle mode as long as the second intensity s1 is significantly smaller than the first intensity s0.

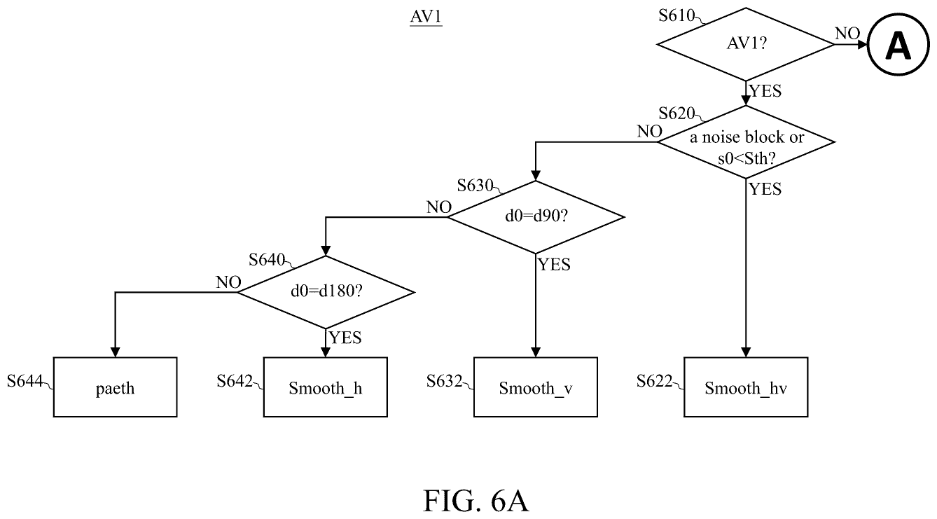

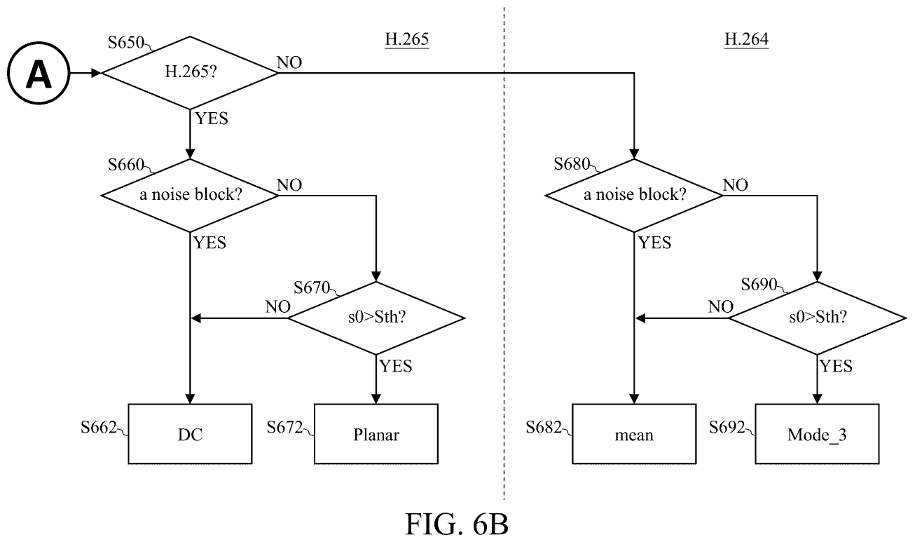

Step S514: The decision mode of the angle preselection circuit 121 is the non-angle mode. The details of step S514 will be elaborated below with reference FIG. 6A to FIG. 6B.

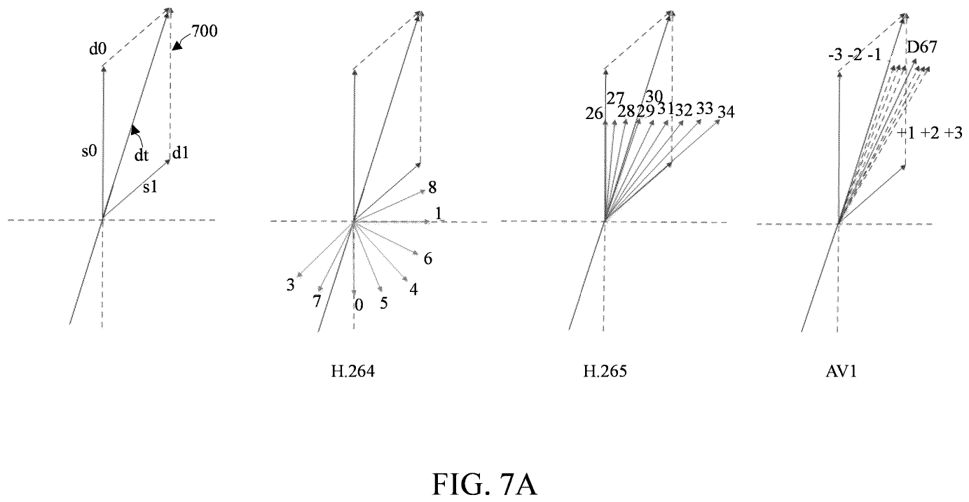

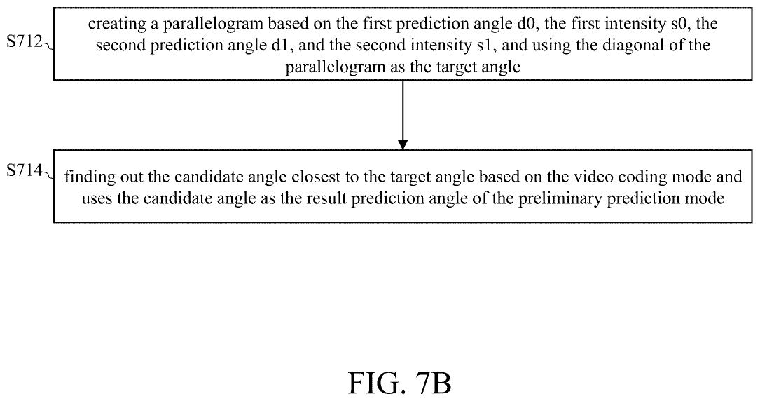

Step S515: The decision mode of the angle preselection circuit 121 is the angle mode. The details of step S515 will be elaborated below with reference FIG. 7A to FIG. 7B.

Step S516: The angle preselection circuit 121 determines the preliminary prediction mode based on the result of step S514 or step S515.

Reference is made to FIGS. 6A to 6B, which are flowcharts for the non-angle mode decision according to an embodiment of the present invention. The flowcharts include the following steps.

Step S610: The angle preselection circuit 121 determines whether the current video coding mode is the AV1 mode. If NO, then the flow proceeds to step S650 in FIG. 6B.

Step S620: The angle preselection circuit 121 determines whether the to-be-predicted block is a noise block, or whether the intensity s0 of the first prediction angle do is smaller than the preset intensity Sth. If the to-be-predicted block is a noise block, or the intensity s0 of the first prediction angle do is smaller than the preset intensity Sth, then the angle preselection circuit 121 determines that the preliminary prediction mode pred_mode is the “Smooth_hv” mode (step S622); otherwise, the flow proceeds to step S630.

Step S630: The angle preselection circuit 121 determines whether the first prediction angle do is the angle d90. If YES, then the angle preselection circuit 121 determines that the preliminary prediction mode pred_mode is the “Smooth_v” mode (step S632); otherwise, the process proceeds to step S640.

Step S640: The angle preselection circuit 121 determines whether the first prediction angle do is the angle d180. If YES, then the angle preselection circuit 121 determines that the preliminary prediction mode pred_mode is the “Smooth h” mode (step S642); otherwise, the angle preselection circuit 121 determines that the preliminary prediction mode pred_mode is the “paeth” mode (step S644).

Step S650: The angle preselection circuit 121 determines whether the current video coding mode is the H.265 mode.

Step S660: The angle preselection circuit 121 determines whether the to-be-predicted block is a noise block. If YES, then the angle preselection circuit 121 determines that the preliminary prediction mode pred_mode is the “DC” mode (step S662).

Step S670: The angle preselection circuit 121 determines whether the intensity s0 of the first prediction angle do is greater than the preset intensity Sth. If YES, then the angle preselection circuit 121 determines that the preliminary prediction mode pred_mode is the “Planar” mode; otherwise, the angle preselection circuit 121 determines that the preliminary prediction mode pred_mode is the “DC” mode.

Step S680 and step S690 are operations in the H.264 mode, corresponding to step S660 and step S670, respectively. The mode “mean” (step S682) and the mode “Mode_3” (step S692) can correspond to the mode “DC” (step S662) and the mode “Planar” (step S672), respectively.

People having ordinary skill in the art can understand the meanings represented by the modes “Smooth_hv,” “Smooth_v,” “Smooth_h,” “paeth,” “DC,” “Planar,” “mean,” and “Mode_3,” so further elaboration is omitted for brevity.

Reference is made to FIGS. 7A to 7B. FIG. 7A is a schematic diagram of the angle mode decision according to an embodiment of the present invention, and FIG. 7B is a flowchart of the angle mode decision according to an embodiment of the present invention. FIGS. 7A to 7B illustrate an example where the first prediction angle do is the angle d90 and the second prediction angle d1 is the angle d45. Reference is made to both FIG. 7A and FIG. 7B.

Step S712: The angle preselection circuit 121 creates a parallelogram 700 based on the first prediction angle do, the first intensity s0, the second prediction angle d1, and the second intensity s1, and uses the diagonal of the parallelogram 700 as the target angle dt.

Step S714: The angle preselection circuit 121 finds out the candidate angle closest to the target angle dt based on the video coding mode and uses the candidate angle as the result prediction angle of the preliminary prediction mode pred_mode. For the H.265 mode and the AV1 mode, the result prediction angles are the candidate angles numbered “29” and “D67,-3,” respectively. When the video coding mode is the H.264 mode, for the luminance component of the 4*4 or 8*8 to-be-predicted block, the result prediction angle is the candidate angle numbered “7.” For the luminance component (Y) of the 16*16 to-be-predicted block and the chrominance components (U and V) of all to-be-predicted blocks, the result prediction angle is the candidate angle numbered “0” (because only the 4 candidate angles “0,” “1,” “2,” and “3” are considered).

In summary, the three video coding modes can share the angle preselection circuit 121. The preliminary prediction mode pred_mode includes the result of the non-angle mode decision (as shown in FIG. 6A to FIG. 6B) or the result of the angle mode decision (as shown in FIG. 7A to FIG. 7B). The angle preselection circuit 121 outputs the preliminary prediction mode pred_mode to the intra-prediction circuit 122, and the intra-prediction circuit 122 references the preliminary prediction mode pred_mode to expedite the intra-prediction.

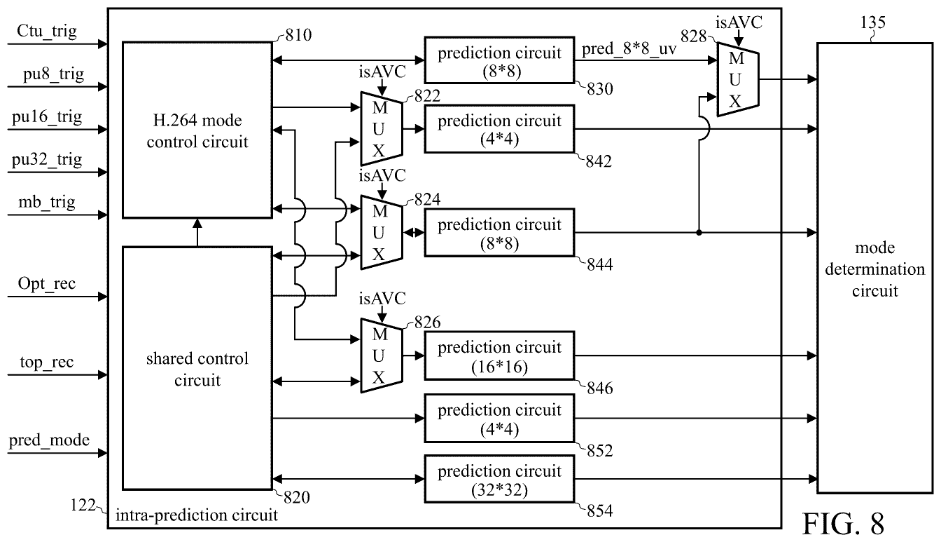

The intra-prediction circuit 122 calculates a most probable mode list for each to-be-predicted block (4*4, 8*8, 16*16, or 32*32) according to the video coding mode. For the H.264 mode, the H.265 mode, and the AV1 mode, the most probable mode list contains 1, 3, and 6 most probable modes, respectively. When the 0th prediction mode (which can be considered the better prediction mode) in the most probable mode list is not equal to the preliminary prediction mode pred_mode, the intra-prediction circuit 122 provides both the better prediction mode and the preliminary prediction mode pred_mode to the mode determination circuit 135 for evaluation. The calculation of the most probable mode list is well known to people having ordinary skill in the art, so further elaboration is omitted for brevity. The following explains the intra-prediction circuit 122 with reference to FIGS. 8 to 18.

Reference is made to FIG. 8, which is a functional block diagram of the intra-prediction circuit 122 according to an embodiment of the present invention. The intra-prediction circuit 122 includes an H.264 mode control circuit 810, a shared control circuit 820, a multiplexer (MUX) 822, a multiplexer 824, a multiplexer 826, a multiplexer 828, a prediction circuit 830, a prediction circuit 842, a prediction circuit 844, a prediction circuit 846, a prediction circuit 852, and a prediction circuit 854.

The intra-prediction circuit 122, in addition to receiving the preliminary prediction mode pred_mode from the angle preselection circuit 121, also receives the small block reconstructed pixels Opt_rec from the mode determination circuit 135, and reads the above (including above-left, directly-above, and above-right) reconstructed pixels top_rec from a line buffer of the video encoder 101. In some embodiments, the line buffer is a part of the storage circuit 140. Here, the “small block” (8*8 or 4*4) is relative to the “macro block” (16*16).

The small block reconstructed pixels Opt_rec are the final reconstructed pixels determined by the mode determination circuit 135 for a to-be-predicted block. The small block reconstructed pixels Opt_rec include the reconstructed pixels at the rightmost column and the reconstructed pixels at the bottommost row of the to-be-predicted block. The H.264 mode control circuit 810 stores the small block reconstructed pixels Opt_rec of the to-be-predicted block for use in the processing of subsequent to-be-predicted blocks. The operating principle of the mode determination circuit 135 is well known to people having ordinary skill in the art, so further elaboration is omitted for brevity.

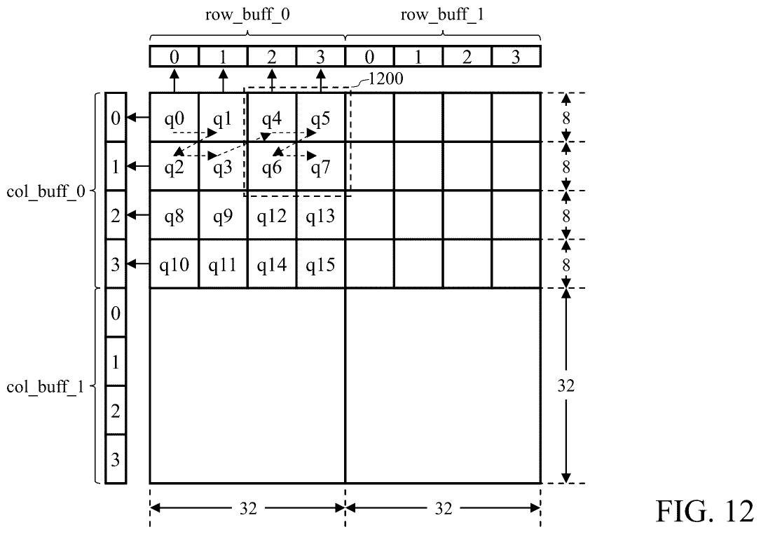

The above reconstructed pixels top_rec are the partial reconstructed pixels at the bottommost row of a to-be-predicted block in the row preceding the to-be-predicted block. The above reconstructed pixels top_rec will be explained in more detail below with reference to FIG. 12.

The H.264 mode control circuit 810 manages the reconstructed pixels, the most probable mode list, and the preliminary prediction mode pred_mode corresponding to the 8*8 and 4*4 to-be-predicted blocks in the H.264 mode. The H.264 mode control circuit 810 outputs the corresponding reconstructed pixels and the preliminary prediction mode pred_mode according to the start signal mb_trig and the start signal pu8_trig, and triggers the corresponding prediction circuit (which will be detailed below).

The shared control circuit 820 manages the reconstructed pixels and the preliminary prediction mode pred_mode corresponding to the 32*32 and 16*16 to-be-predicted block in the three video coding modes, and manages the reconstructed pixels and the preliminary prediction mode pred_mode corresponding to the 8*8 and 4*4 to-be-predicted blocks in the H.265 mode and the AV1 mode. The shared control circuit 820 outputs the corresponding reconstructed pixels and the preliminary prediction mode pred_mode according to the start signal Ctu_trig, the start signal pu32_trig, the start signal pu16_trig, and the start signal pu8_trig, and triggers the corresponding prediction circuit (which will be detailed below).

The multiplexers 822, 824, and 826 are coupled to the H.264 mode control circuit 810 and the shared control circuit 820. The multiplexer 822, the multiplexer 824, and the multiplexer 826 are also respectively coupled to the prediction circuit 842, the prediction circuit 844, and the prediction circuit 846. The multiplexer 828 is coupled to the prediction circuit 830, the prediction circuit 844, and the mode determination circuit 135. The multiplexers 822, 824, 826, and 828 make selections according to the select signal isAVC. When the select signal isAVC indicates that the video coding mode is the H.264 mode (i.e., AVC), the multiplexer 822, the multiplexer 824, and the multiplexer 826 select the output of the H.264 mode control circuit 810, while the multiplexer 828 selects the output of the prediction circuit 830. When the select signal isAVC indicates that the video coding mode is not the H.264 mode (i.e., the video coding mode is the H.265 mode or the AV1 mode), the multiplexer 822, the multiplexer 824, and the multiplexer 826 select the output of the shared control circuit 820, while the multiplexer 828 selects the output of the prediction circuit 844.

In some embodiments, the select signal isAVC is issued by a processing unit (a central processing unit, a microprocessor, or a digital signal processor) of the electronic device where the video encoder 101 is disposed. The processing unit controls the video coding mode of the video encoder 101 through the select signal isAVC.

The prediction circuits 830, 842, 844, 846, 852, and 854 respectively process the to-be-predicted blocks with sizes of 8*8, 4*4, 8*8, 16*16, 4*4, and 32*32. The prediction circuit 830 is dedicated to the H.264 mode. The prediction circuits 842, 844, and 846 are shared by the H.264 mode, the H.265 mode, and the AV1 mode. The prediction circuit 852 and the prediction circuit 854 are shared by the H.265 mode and the AV1 mode.

As mentioned above, because multiple circuits in the intra-prediction circuit 122 are shared by two or even three video coding modes, the video encoder 101 of the present invention can save circuit area and cost. The implementation details of the prediction circuits will be discussed in detail later. Furthermore, because some prediction circuits can be turned off (disabled) in certain video coding modes (e.g., the prediction circuit 852 and the prediction circuit 854 can be turned off in the H.264 mode, or the H.264 mode control circuit 810 and the prediction circuit 830 can be turned off in the H.265 mode and the AV1 mode), power can be saved.

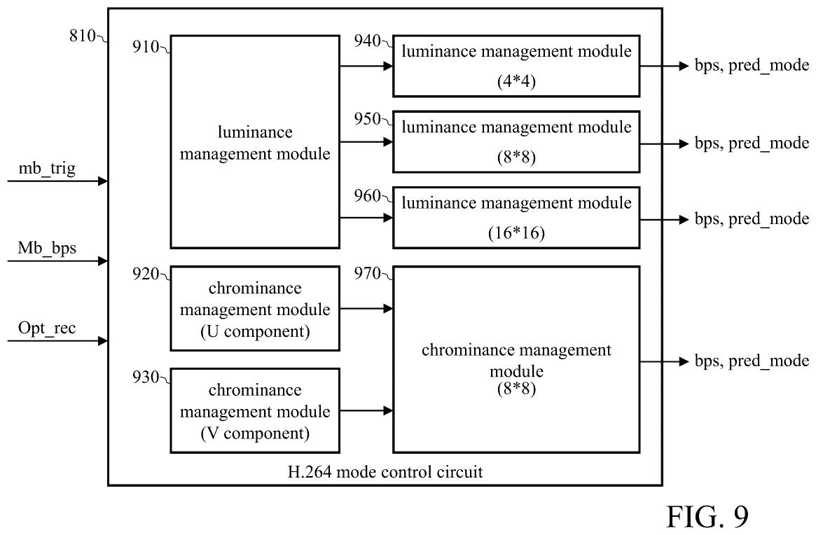

Reference is made to FIG. 9, which is a functional block diagram of the H.264 mode control circuit 810 according to an embodiment of the present invention. The H.264 mode control circuit 810 includes a luminance management module 910, a chrominance management module (U component) 920, a chrominance management module (V component) 930, a luminance management module 940, a luminance management module 950, a luminance management module 960, and a chrominance management module 970.

The H.264 mode control circuit 810 receives the start signal mb_trig from the control circuit 110, receives the macro block reconstructed pixels Mb_bps from the shared control circuit 820, and receives the small block reconstructed pixels Opt_rec from the mode determination circuit 135. The macro block reconstructed pixels Mb_bps include the reconstructed pixels of the luminance component and the reconstructed pixels of the chrominance components of a macro block. The small block reconstructed pixels Opt_rec include the reconstructed pixels of the luminance component and reconstructed pixels of the chrominance components of an 8*8 or 4*4 block.

The luminance management module 910 is used to store and manage the reconstructed pixels bps and the preliminary prediction mode pred_mode of the luminance component at the macro-block level, and to trigger the luminance management modules 940, 950, and 960 to start working. More specifically, because a macro block contains one 16*16 to-be-predicted block, four 8*8 to-be-predicted blocks, and sixteen 4*4 to-be-predicted blocks, for a macro block, the luminance management module 910 triggers the luminance management module 960 once, the luminance management module 950 four times, and the luminance management module 940 sixteen times. When triggered, the luminance management modules 940, 950, and 960 output the corresponding reconstructed pixels bps and the preliminary prediction mode pred_mode.

The chrominance management module (U component) 920 is used to store and manage the reconstructed pixels bps and the preliminary prediction mode pred_mode of the chrominance (U) component at the macro-block level, and to trigger the chrominance management module 970 to start working.

The chrominance management module (V component) 930 is used to store and manage the reconstructed pixels bps of the chrominance (V) component at the macro-block level. It should be noted that the preliminary prediction mode pred_mode of the chrominance (V) component is the same as the preliminary prediction mode pred_mode of the chrominance (U) component.

For a macro block, the chrominance management module (U component) 920 and the chrominance management module (V component) 930 each trigger the chrominance management module 970 once.

The luminance management modules 940, 950, and 960 are respectively used to process sixteen 4*4 to-be-predicted blocks, four 8*8 to-be-predicted blocks, and one 16*16 to-be-predicted block of a macro block. The luminance management modules 940, 950, and 960 all process the luminance component.

The luminance management module 940 is used to generate the most probable mode list for each 4*4 to-be-predicted block, provide the corresponding reconstructed pixels bps (i.e., the reconstructed pixels bps required for intra-prediction), select one or two preliminary prediction mode(s) pred_mode for prediction, and trigger the prediction circuit 842 of FIG. 8 to start working.

The luminance management module 950 is used to generate the most probable mode list for each 8*8 to-be-predicted block, provide the corresponding reconstructed pixels bps, select one or two preliminary prediction mode(s) pred_mode for prediction, and trigger the prediction circuit 844 in FIG. 8 to start working.

The luminance management module 960 is used to generate the most probable mode list for the 16*16 to-be-predicted block, provide the corresponding reconstructed pixels bps, select one or two preliminary prediction mode(s) pred_mode for prediction, and trigger the prediction circuit 846 in FIG. 8 to start working.

The chrominance management module 970 is used to process the chrominance components (the U component and the V component) of a macro block. The chrominance management module 970 provides the reconstructed pixels bps (U component and V component) corresponding to the macro block, selects one or two preliminary prediction mode pred_mode(s) for prediction, and triggers the prediction circuit 830 in FIG. 8 to predict the U component and V component (first predicting the U component, then predicting the V component).

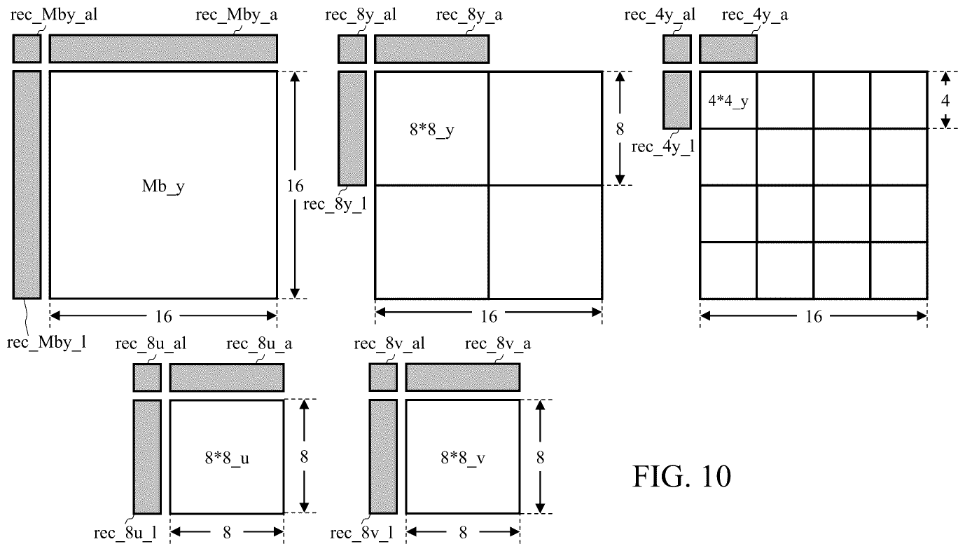

Reference is made to FIG. 10, which is a schematic diagram of the reconstructed pixels corresponding to (i.e., referenced by) multiple to-be-predicted blocks according to the present invention. For the luminance component of a macro block (please refer to the to-be-predicted block Mb_y), the above, above-left, and left reconstructed pixels are rec_Mby_a, rec_Mby_a1, and rec_Mby_1, respectively. For a macro block's chrominance components (please refer to the to-be-predicted block 8*8_u and the to-be-predicted block 8*8_v), the above reconstructed pixels are rec_8u_a and rec_8v_a, respectively, the above-left reconstructed pixels are rec_8u_al and rec_8v_a1, respectively, and the left reconstructed pixels are rec_8u_1 and rec_8v 1, respectively. For the luminance component of an 8*8 to-be-predicted block (please refer to the to-be-predicted block 8*8_y), the above, above-left, and left reconstructed pixels are rec_8y_a, rec_8y_a1, and rec_8y_1, respectively. For the luminance component of a 4*4 to-be-predicted block (please refer to the to-be-predicted block 4*4_y), the above, above-left, and left reconstructed pixels are rec_4y_a, rec_4y_a1, and rec_4y_1, respectively.

Reference is made to FIG. 9 and FIG. 10. The macro block reconstructed pixels Mb_bps include the reconstructed pixels rec_Mby_a, rec_Mby_a1, rec_Mby_1, rec_8u_a, rec_8u_a1, rec_8u_1, rec_8v_a, rec_8v_a1, and rec_8v 1. The small block reconstructed pixels Opt_rec include the reconstructed pixels rec_8y_a, rec_8y_a1, rec_8y_1, rec_4y_a, rec_4y_a1, and rec_4y_1.

The H.264 mode control circuit 810 is responsible for managing the reconstructed pixels (rec_8y_a, rec_8y_a1, and rec_8y_1) corresponding to the to-be-predicted block 8*8_y as well as the reconstructed pixels (rec_4y_a, rec_4y_a1, and rec_4y_1) corresponding to the to-be-predicted block 4*4_y.

The reconstructed pixels managed by the shared control circuit 820 include (but are not limited to) the reconstructed pixels (rec_Mby_a, rec_Mby_a1, and rec_Mby_1) corresponding to the to-be-predicted block Mb_y, the reconstructed pixels (rec_8u_a, rec_8u_a1, and rec_8u_1) corresponding to the to-be-predicted block 8*8_u, and the reconstructed pixels (rec_8v_a, rec_8v_a1, and rec_8v_1) corresponding to the to-be-predicted block 8*8_v. In addition, the shared control circuit 820 is also responsible for managing the preliminary prediction mode pred_mode of the to-be-predicted block Mb_y.

In some embodiments, the aforementioned “manage” or “management” refers to reading the corresponding reconstructed pixels bps and preliminary prediction mode pred_mode from the storage circuit 140 according to the start signal (the start signal Ctu_trig, mb_trig, pu32_trig, pu16_trig, or pu8_trig), providing the reconstructed pixels bps and preliminary prediction mode pred_mode to the corresponding prediction circuit (the prediction circuit 830, 842, 844, 846, 852, or 854), and triggering the corresponding prediction circuit.

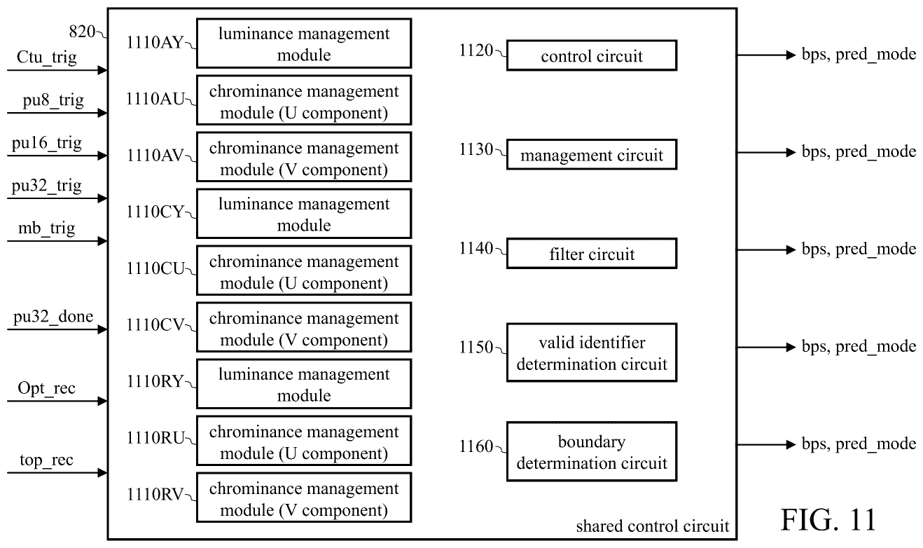

Reference is made to FIG. 11, which is a functional block diagram of the shared control circuit 820 according to an embodiment of the present invention. The shared control circuit 820 includes a luminance management module 1110AY, a chrominance management module (U component) 1110AU, a chrominance management module (V component) 1110AV, a luminance management module 1110CY, a chrominance management module (U component) 1110CU, a chrominance management module (V component) 1110CV, a luminance management module 1110RY, a chrominance management module (U component) 1110RU, a chrominance management module (V component) 1110RV, a control circuit 1120, a management circuit 1130, a filter circuit 1140, a valid identifier determination circuit 1150, and a boundary determination circuit 1160.

Reference is made to FIG. 12, which is a schematic diagram of the buffer circuit according to an embodiment of the present invention. The intra-prediction circuit 122 sequentially processes the to-be-predicted blocks q0→q1→q2→q3→q4→q5→q6 →q7 (as indicated by the arrows in the figure). The buffer circuit row_buff 0 and the buffer circuit row_buff_1 buffer the reconstructed pixels at the bottommost row of an 8*8 to-be-predicted block at each address (0 to 3). The buffer circuit col_buff 0 and the buffer circuit col_buff_1 buffer the reconstructed pixels at the rightmost column of a to-be-predicted block at each address (0 to 3). In some embodiments, the buffer circuit row_buff_0, the buffer circuit row_buff_1, the buffer circuit col_buff_0, and the buffer circuit col_buff_1 are parts of the storage circuit 140 in FIG. 1.

Continuing the previous paragraph, each address (0 to 3) of the buffer circuit row_buff_0, the buffer circuit row_buff_1, the buffer circuit col_buff_0, and the buffer circuit col_buff_1 stores the luminance component of 8 reconstructed pixels, or stores the chrominance components of 8 reconstructed pixels (4 U components and 4 V components).

The following explains the above reconstructed pixels top_rec (including the above-left, directly-above, and above-right pixels). For example, with respect to the to-be-predicted block 1200, the corresponding above-left reconstructed pixel includes the rightmost pixel at the first address of the buffer circuit row_buff_0; the corresponding directly-above reconstructed pixels include all the pixels at the second address and all the pixels at the third address of the buffer circuit row_buff_0; the corresponding above-right reconstructed pixels include the leftmost pixel at the 0th address of the buffer circuit row_buff_1.

Reference is made to FIG. 11 and FIG. 12. The luminance management module 1110CY, the chrominance management module (U component) 1110CU, and the chrominance management module (V component) 1110CV are responsible for managing the preliminary prediction modes pred_mode and the reconstructed pixels of the 8*8, 16*16, and 32*32 to-be-predicted blocks. More specifically, the luminance management module 1110CY is responsible for managing the storage and updating of the luminance values in the buffer circuit col_buff_0 and the buffer circuit col_buff_1, while the chrominance management module (U component) 1110CU and the chrominance management module (V component) 1110CV are responsible for managing the storage and updating of the chrominance values of the buffer circuit col buff_0 and the buffer circuit col_buff_1. For example, when the mode determination circuit 135 has finished processing the to-be-predicted block q0, the shared control circuit 820 obtains the reconstructed pixels of the to-be-predicted block q0 (i.e., the small block reconstructed pixels Opt_rec), and the luminance management module 1110CY stores the luminance values of the reconstructed pixels at the rightmost column into the 0^{th} address of the buffer circuit col_buff_0. After the mode determination circuit 135 finishes processing the to-be-predicted block q1, the shared control circuit 820 obtains the reconstructed pixels of the to-be-predicted block q1, and the luminance management module 1110CY stores the luminance values of the reconstructed pixels at the rightmost column into the 0^{th} address of the buffer circuit col_buff_0, replacing the reconstructed pixels at the rightmost column of the to-be-predicted block q0.

Continuing the previous paragraph, similarly, the luminance management module 1110RY, the chrominance management module (U component) 1110RU, and the chrominance management module (V component) 1110RV perform similar management on the buffer circuit row_buff_0 and the buffer circuit row_buff_1. More specifically, the luminance management module 1110RY stores the luminance values of multiple reconstructed pixels at the bottommost row of a to-be-predicted block into the buffer circuit row_buff_0 or the buffer circuit row_buff_1, while the chrominance management module (U component) 1110RU and the chrominance management module (V component) 1110RV store the chrominance values of the reconstructed pixels at the bottommost row of the to-be-predicted block into the buffer circuit row_buff_0 or the buffer circuit row_buff_1.

As shown in FIG. 10, the reconstructed pixels corresponding to (i.e., referenced by) each to-be-predicted block include the above-left reconstructed pixels (e.g., the reconstructed pixels rec_Mby_a1, rec_8y_a1, rec_8u_a1, rec_8v_a1, and rec_4y_a1). However, for example (please refer to FIG. 12), when the intra-prediction of the to-be-predicted block q1 is completed, the 0^{th} address of the buffer circuit col_buff_0 stores the reconstructed pixels at the rightmost column of the to-be-predicted block q1 (i.e., overwriting the reconstructed pixels at the rightmost column of the to-be-predicted block q0), and when the intra-prediction of the to-be-predicted block q2 is completed, the 0^{th} address of the buffer circuit row_buff_0 stores the reconstructed pixels at the bottommost row of the to-be-predicted block q2 (i.e., overwriting the reconstructed pixels at the bottommost row of the to-be-predicted block q0), resulting in the intra-prediction circuit 122 being unable to obtain the above-left reconstructed pixel of the to-be-predicted block q3 (corresponding to the reconstructed pixel rec_8y_a1, rec_8u_a1, or rec_8v_al in FIG. 10, i.e., the reconstructed pixel at the bottom-right corner of the to-be-predicted block q0). Therefore, the shared control circuit 820 uses the luminance management module 1110AY to manage the storage and update of the luminance value of the above-left reconstructed pixel and uses the chrominance management module (U component) 1110AU and the chrominance management module (V component) 1110AV to manage the storage and update of the chrominance value of the above-left reconstructed pixel.

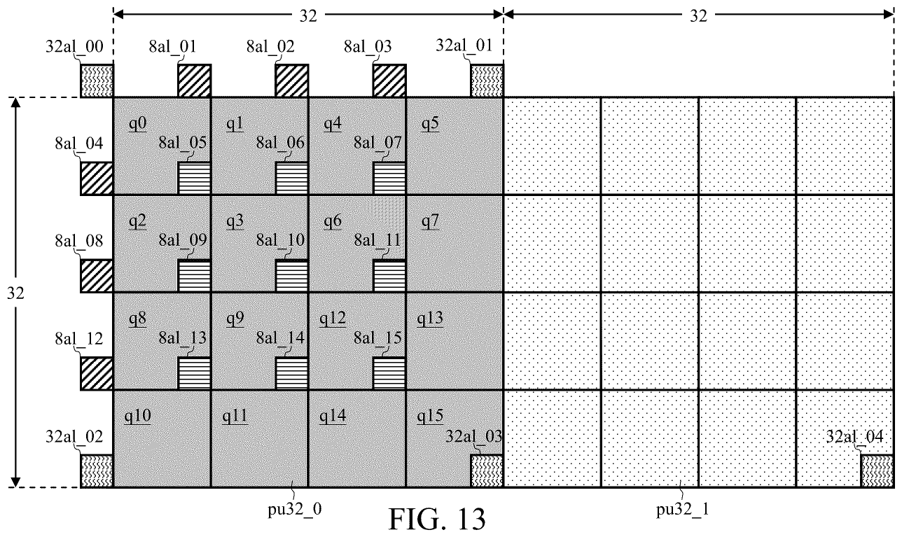

Reference is made to FIG. 13, which is a schematic diagram of the above-left reconstructed pixels according to the present invention. The reconstructed pixel 32a1_00 is the above-left reconstructed pixel referenced by the intra-prediction circuit 122 when it is performing the intra-prediction on the 32*32 to-be-predicted block pu32_0 (gray area, containing 16 8*8 to-be-predicted blocks q0 to q15) and the to-be-predicted block q0. The reconstructed pixels 8a1_01 to 8a1_15 are the above-left reconstructed pixels referenced by the intra-prediction circuit 122 when it is performing the intra-prediction on 15 to-be-predicted blocks q1, q4, q5, q2, q3, q6, q7, q8, q9, q12, q13, q10, q11, q14, and q15. The reconstructed pixel 32a1_01 is the above-left reconstructed pixel referenced by the intra-prediction circuit 122 when it is performing intra-prediction on the 32*32 to-be-predicted block pu32_1 (dotted area). Similarly, the reconstructed pixel 32a1_02, the reconstructed pixel 32a1_03, and the reconstructed pixel 32a1_04 are the above-left reconstructed pixels of other 32*32 to-be-predicted blocks (not shown).

Reference is made to FIG. 11 and FIG. 13. The shared control circuit 820 manages the above-left reconstructed pixels of a to-be-predicted block according to the start signal pu8_trig, the start signal pu32_trig, and the end signal pu32_done. The shared control circuit 820 (more specifically, the luminance management module 1110AY, the chrominance management module (U component) 1110AU, and the chrominance management module (V component) 1110AV) manages the reconstructed pixels based on the following rules.
(1) When the shared control circuit 820 receives the start signal pu32_trig, the shared control circuit 820 stores the bottom-right reconstructed pixels that surround the 32*32 to-be-predicted block but are not located at the corners. For example, the bottom-right reconstructed pixels that surround the to-be-predicted block pu32_0 include the reconstructed pixel 32a1_00, the reconstructed pixel 8a1_01, the reconstructed pixel 8a1_02, the reconstructed pixel 8a1_03, the reconstructed pixel 32a1_01, the reconstructed pixel 8a1_04, the reconstructed pixel 8a1_08, the reconstructed pixel 8a1_12, and the reconstructed pixel 32a1_02, wherein the reconstructed pixel 32a1_00, the reconstructed pixel 32a1_01, the reconstructed pixel 32a1_02, and the reconstructed pixel 32a1_03 are located at the corners of the 32*32 to-be-predicted block. In other words, in response to the start signal pu32_trig, the shared control circuit 820 stores the reconstructed pixel 8a1_01, the reconstructed pixel 8a1_02, the reconstructed pixel 8a1_03, the reconstructed pixel 8a1_04, the reconstructed pixel 8a1_08, and the reconstructed pixel 8a1_12 to the storage circuit 140.
(2) When a shared control circuit 820 receives a start signal pu8_trig of a current 8*8 to-be-predicted block, the shared control circuit 820 stores the bottom-right reconstructed pixel from an 8*8 to-be-predicted block on the left side of the current 8*8 to-be-predicted block. For example, in response to the start signal pu8_trig of the to-be-predicted block q1, the shared control circuit 820 stores the reconstructed pixel 8a1_05 to the storage circuit 140.
(3) When the shared control circuit 820 receives the end signal pu32_done, the shared control circuit 820 stores the bottom-right reconstructed pixel of the 32*32 to-be-predicted block. For example, when determining the block coding method of the to-be-predicted block pu32_0, the mode determination circuit 135 sends the end signal pu32_done to the control circuit 110, and the control circuit 110 then transmits the end signal pu32_done to the prediction circuit 120. The intra-prediction circuit 122 stores the reconstructed pixel 32a1_03 to the storage circuit 140 according to the end signal pu32_done.

Reference is made to FIG. 11. The control circuit 1120 is responsible for managing the operation of other circuits in the shared control circuit 820, and is responsible for triggering the prediction circuits 842, 844, 846, 852, and 854.

Reference is made to FIG. 11. The minimum unit managed by the luminance management module 1110AY, the chrominance management module (U component) 1110AU, the chrominance management module (V component) 1110AV, the luminance management module 1110CY, the chrominance management module (U component) 1110CU, the chrominance management module (V component) 1110CV, the luminance management module 1110RY, the chrominance management module (U component) 1110RU, and the chrominance management module (V component) 1110RV is an 8*8 to-be-predicted block, while the reconstructed pixels bps and the preliminary prediction modes pred_mode corresponding to the 4*4 to-be-predicted blocks are managed by the management circuit 1130. It should be noted that, in the H.264 mode, the management circuit 1130 is disabled to save power (the 4*4 to-be-predicted blocks are processed by the H.264 mode control circuit 810).

Reference is made to FIG. 11. The filter circuit 1140 is used to filter the reconstructed pixels bps in the H.265 mode and the AV1 mode. In some embodiments, the filter circuit 1140 is a low-pass filter circuit. In the H.264 mode, the filter circuit 1140 is disabled to save power.

Reference is made to FIG. 11. The shared control circuit 820 further provides the reconstructed pixels bps based on the output of the valid identifier determination circuit 1150 and the output of the boundary determination circuit 1160. The valid identifier determination circuit 1150 is used to determine whether the to-be-predicted block can be obtained. For example, the valid identifier being 1 (0) indicates that the to-be-predicted block can (cannot) be obtained. The boundary determination circuit 1160 is used to determine whether the to-be-predicted block is located at a boundary of a frame. For example, the boundary value being 1 (0) indicates that the to-be-predicted block is located (not located) at the boundary.

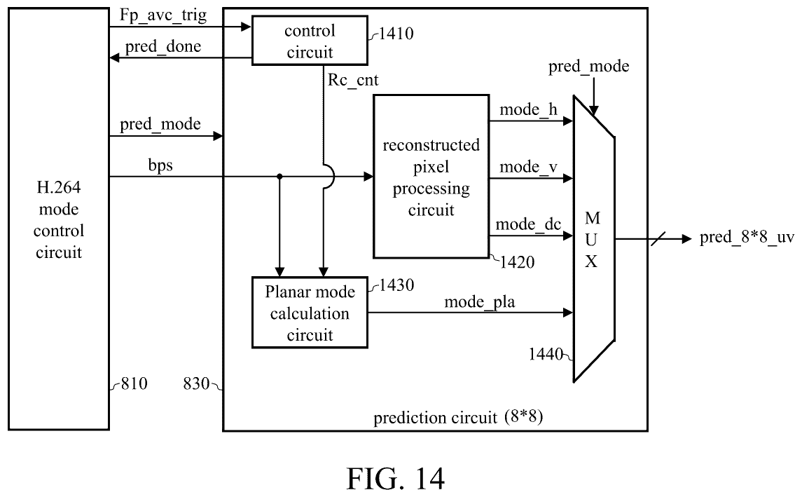

Reference is made to FIG. 14, which is a functional block diagram of the prediction circuit 830 according to an embodiment of the present invention. The prediction circuit 830 includes a control circuit 1410, a reconstructed pixel processing circuit 1420, a Planar mode calculation circuit 1430, and a multiplexer 1440, all of which are coupled to each other. The prediction circuit 830 is a circuit dedicated to the H.264 mode, responsible for the prediction of the chrominance components in the H.264 mode for each 8*8 to-be-predicted block. The chrominance components in the H.264 mode include 4 prediction modes: H, V, DC, and Planar. The prediction circuit 830 is coupled to the H.264 mode control circuit 810 and receives, from the H.264 mode control circuit 810, the control signal Fp_avc_trig, as well as the reconstructed pixels bps and the preliminary prediction mode pred_mode, both of which correspond to the to-be-predicted block.

The control circuit 1410 generates the count value Rc_cnt based on the control signal Fp_avc_trig and the operation clock (not shown). The control signal Fp_avc_trig indicates the start of a 4*4 to-be-predicted block.

The count value Rc_cnt indicates the column number and/or the row number of the target to-be-predicted block that the prediction circuit 830 is currently processing. When the prediction circuit 830 finishes processing the target to-be-predicted block, the control circuit 1410 outputs a completion signal pred_done to the H.264 mode control circuit 810.

The reconstructed pixel processing circuit 1420 processes the reconstructed pixels bps to generate the predicted values mode_h, mode_v, and mode_dc (corresponding to the prediction modes H, V, and DC, respectively). For example (please refer to FIG. 12), with respect to the to-be-predicted block q1, the reconstructed pixel processing circuit 1420 uses the reconstructed pixels at the 0th address of the buffer circuit col_buff_0 (the left reconstructed pixels) to generate the predicted value mode_h for the prediction mode H, uses the reconstructed pixels at the first address of the buffer circuit row_buff_0 (the above reconstructed pixels) to generate the predicted value mode_v for the prediction mode V, and uses the left reconstructed pixels and the above reconstructed pixels to generate the predicted value mode_dc of the prediction mode DC.

The Planar mode calculation circuit 1430 calculates the reconstructed pixels bps based on the count value Rc_cnt to obtain the predicted value mode_p1a for the Planar mode. The implementation details of the Planar mode calculation circuit 1430 are well known to people having ordinary skill in the art, so further elaboration is omitted for brevity.

The multiplexer 1440 selects one of the predicted values mode_h, mode_v, mode_dc, and mode_p1a as the predicted pixel pred_8*8_uv according to the preliminary prediction mode pred_mode. The predicted pixel pred_8*8_uv is a part of the intra-prediction image outputted by the intra-prediction circuit 122. In some embodiments, the prediction circuit 830 outputs a column or a row of an intra-prediction image at a time.

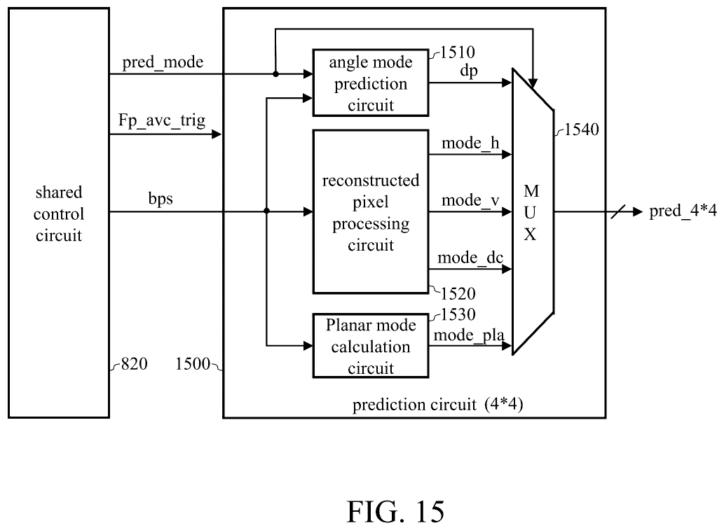

Reference is made to FIG. 15, which is a functional block diagram of the prediction circuit according to another embodiment of the present invention. The prediction circuit 1500 includes an angle mode prediction circuit 1510, a reconstructed pixel processing circuit 1520, a Planar mode calculation circuit 1530, and a multiplexer 1540. The prediction circuit 1500 receives, from the shared control circuit 820, a control signal Fp_avc_trig as well as the reconstructed pixels bps and the preliminary prediction mode pred_mode, both of which correspond to the to-be-predicted block. The prediction circuit 842 and the prediction circuit 852 in FIG. 8 can be implemented using the prediction circuit 1500.

The angle mode prediction circuit 1510 generates the predicted value dp based on the preliminary prediction mode pred_mode and the reconstructed pixels bps. The function of the reconstructed pixel processing circuit 1520 is similar to the function of the reconstructed pixel processing circuit 1420. The function of the Planar mode calculation circuit 1530 is similar to the function of the Planar mode calculation circuit 1430. The multiplexer 1540 selects one of the predicted value dp, the predicted value mode_h, the predicted value mode_v, the predicted value mode_dc, and the predicted value mode_p1a as the predicted pixel pred_4*4 according to the preliminary prediction mode pred_mode.

In some embodiments, the prediction circuit 1500 outputs 16 predicted pixels of an entire 4*4 to-be-predicted block at a time. Therefore, unlike the prediction circuit 830 in FIG. 14, the prediction circuit 1500 may not require a control circuit to provide the count value Rc_cnt.

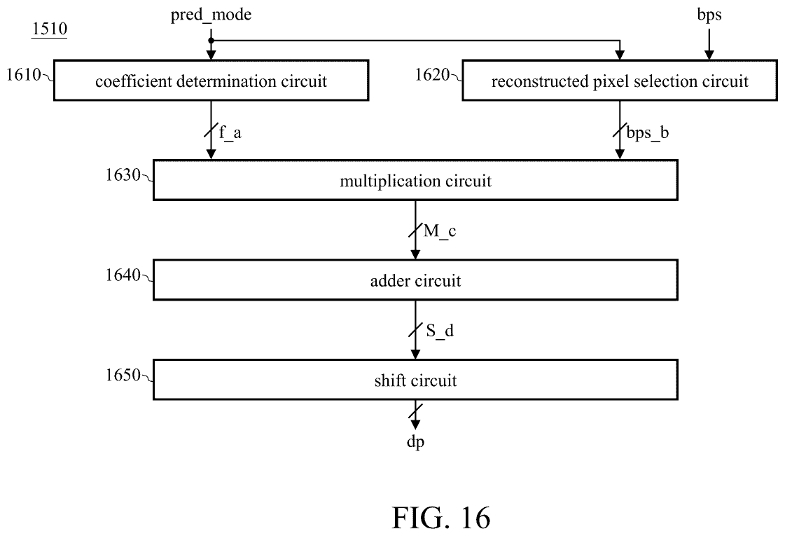

Reference is made to FIG. 16, which is a functional block diagram of the angle mode prediction circuit 1510 according to an embodiment of the present invention. The angle mode prediction circuit 1510 includes a coefficient determination circuit 1610, a reconstructed pixel selection circuit 1620, a multiplication circuit 1630, an adder circuit 1640, and a shift circuit 1650, all of which are coupled to each other.

The coefficient determination circuit 1610 stores multiple multiplication coefficient tables. The H.265 mode and the AV1 mode each have their own multiplication coefficient table. For the H.264 mode, because the coefficients have only three types ((1,2,1), (1,3), and (3,1)), the coefficient determination circuit 1610 can implement the three types of coefficients through a logic circuit. The coefficient determination circuit 1610 determines a set of coefficients f_a according to the preliminary prediction mode pred_mode and the positions of the to-be-predicted pixels in the current to-be-predicted block. The number of coefficients is related to the number of to-be-predicted pixels (predicting one pixel value requires two coefficients). In order to improve the calculation speed, the hardware simultaneously predicts multiple consecutive to-be-predicted pixels (in the same row or the same column). Specifically, each time, a lookup table is referred to based on the preliminary prediction mode pred_mode and the position of the first to-be-predicted pixel (the leftmost or topmost to-be-predicted pixel among the multiple consecutive to-be-predicted pixels) in the current to-be-predicted block to obtain the required multiple coefficients. For example, when predicting 4 to-be-predicted pixels at a time, 8 coefficients are obtained from the lookup table at once. For the 4*4, 8*8, 16*16, and 32*32 to-be-predicted blocks, different lookup table schemes are designed according to different requirements. At the start of video coding, the coefficient table is loaded according to the current mode (H.265 or AV1).

The reconstructed pixel selection circuit 1620 selects a set of reconstructed pixels bps_b from the reconstructed pixels bps based on the preliminary prediction mode pred_mode and the positions of the to-be-predicted pixels. The number of reconstructed pixels bps_b is related to the number of to-be-predicted pixels. For the H.265 mode and the AV1 mode, predicting one pixel value requires two reconstructed pixels bps_b. In order to improve the calculation speed, the hardware simultaneously predicts multiple consecutive to-be-predicted pixels (in the same row or the same column). The adjacent to-be-predicted pixels reuse a reconstructed pixel bps_b. For example, only 5 reconstructed pixels bps_b are needed for predicting a column (or a row) of 4 consecutive to-be-predicted pixels; only 9 reconstructed pixels bps_b are needed for predicting a column (or a row) of 8 consecutive pixels. For the 4*4, 8*8, 16*16, and 32*32 to-be-predicted blocks, there are respective reconstructed pixels bps arrays available for selection. For the H.264 mode, predicting a to-be-predicted pixel requires 2 or 3 reconstructed pixels bps. It is necessary to select 3 reconstructed pixels bps for each to-be-predicted pixel based on the preliminary prediction mode pred_mode and the position of the first to-be-predicted pixel in the to-be-predicted block (if only 2 bps are needed, the last bps is an invalid pbs and will not be used).

The multiplication circuit 1630 multiplies the coefficients f_a with the reconstructed pixels bps_b to obtain the products M_c. The number of products M_c depends on the number of to-be-predicted pixels. For example, in cases where a consecutive N to-be-predicted pixels are predicted at a time (N is generally 2″, where n is a positive integer greater than or equal to 2), 2 times N products are obtained, and each to-be-predicted pixel corresponds to 2 products. More specifically, the multiplication circuit 1630 includes multiple multipliers (not shown), and the number of multipliers depends on how many to-be-predicted pixels are predicted at one time. Each multiplier multiplies a coefficient f_a with a reconstructed pixel bps_b to produce a product M_c. The 4*4, 8*8, 16*16, and 32*32 to-be-predicted blocks have their respective prediction schemes; that is, they correspond to multiplication circuits with different numbers of multipliers. According to actual needs, the multiplier circuits of different to-be-predicted blocks can operate simultaneously, and it is also possible to turn off the multiplier circuits of some to-be-predicted blocks to reduce power consumption.

For the H.264 mode, because the coefficients have only three combinations ((1,2,1), (1,3), and (3,1)), the implementation can be achieved through addition, without the need for a multiplication circuit. Therefore, in the H.264 mode, the multiplier circuit can be completely turned off to reduce power consumption.

The adder circuit 1640 performs the addition operation. For the H.265 mode and the AV1 mode, the adder circuit 1640 adds two products M_c to generate a sum S_d (S_d=M_2d+M_2d+16). Predicting several consecutive to-be-predicted pixels at one time, such as N to-be-predicted pixels (N is generally 2″, where n is a positive integer greater than or equal to 2), obtains N sums. For the H.264 mode, if the number of selected reconstructed pixels bps_b is 2 (bps_b_0 and bps_b_1), and the coefficients are 1 and 3, then S_d=bps_b_0+bps_b_1+bps_b_1+bps_b_1+2; if the number of selected reconstructed pixels bps_b is 3 (bps_b_0, bps_b_1, and bps_b_2), the coefficients are 1, 2, and 1, then S_d=bps_b_0+bps_b_1+bps_b_1+bps_b_2+2.

The shift circuit 1650 shifts each sum S_d to generate a corresponding predicted value dp. The purpose of the shift is to normalize the result. For the H.265 mode and the AV1 mode, the sum is shifted right by 5 bits; for the H.264 mode, the sum is shifted right by 2 bits.

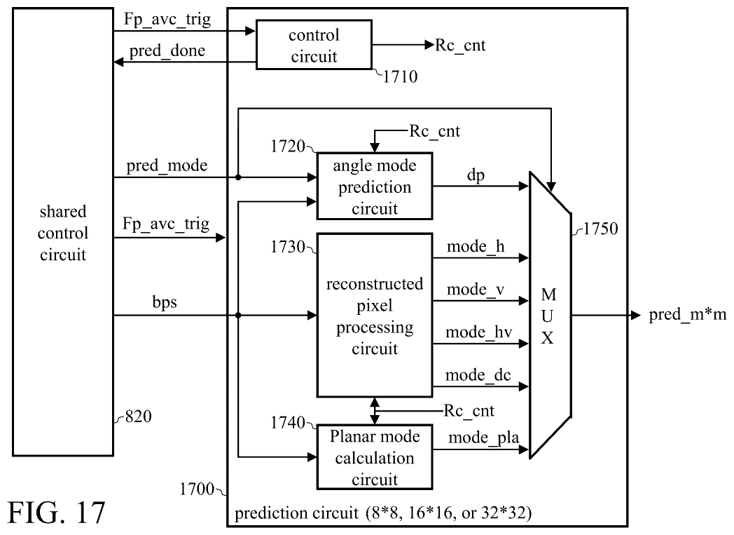

Reference is made to FIG. 17, which is a functional block diagram of the prediction circuit according to another embodiment of the present invention. The prediction circuit 1700 includes a control circuit 1710, an angle mode prediction circuit 1720, a reconstructed pixel processing circuit 1730, a Planar mode calculation circuit 1740, and a multiplexer 1750. The prediction circuit 1700 receives the control signal Fp_avc_trig from the shared control circuit 820, as well as the reconstructed pixels bps and the preliminary prediction mode pred_mode, both of which correspond to the to-be-predicted block. The prediction circuit 844, the prediction circuit 846, and the prediction circuit 854 in FIG. 8 can be implemented using the prediction circuit 1700.

The control circuit 1710 is similar to the control circuit 1410, so further elaboration is omitted for brevity.

The angle mode prediction circuit 1720 calculates the reconstructed pixels bps based on the count value Rc_cnt and the preliminary prediction mode pred_mode to generate the predicted value dp.

The reconstructed pixel processing circuit 1730 processes the reconstructed pixels bps to generate the predicted value mode_h, the predicted value mode_v, the predicted value mode_hv, and the predicted value mode_dc, which correspond to the prediction modes “Smooth_h,” “Smooth_v,” “Smooth_hv,” and “DC,” respectively. The function of the reconstructed pixel processing circuit 1730 is similar to the function of the reconstructed pixel processing circuit 1420.

The function of the Planar mode calculation circuit 1740 is similar to the function of the Planar mode calculation circuit 1430. The implementation details of the Planar mode calculation circuit 1740 are well known to people having ordinary skill in the art, so further elaboration is omitted for brevity.

The multiplexer 1750 selects one of the predicted values dp, mode_h, mode_v, mode_hv, mode_dc, and mode_p1a as the predicted pixel pred_m*m (m may be 8, 16, or 32) according to the preliminary prediction mode pred_mode. In some embodiments, the prediction circuit 1700 outputs a column or a row of the intra-prediction image at a time.

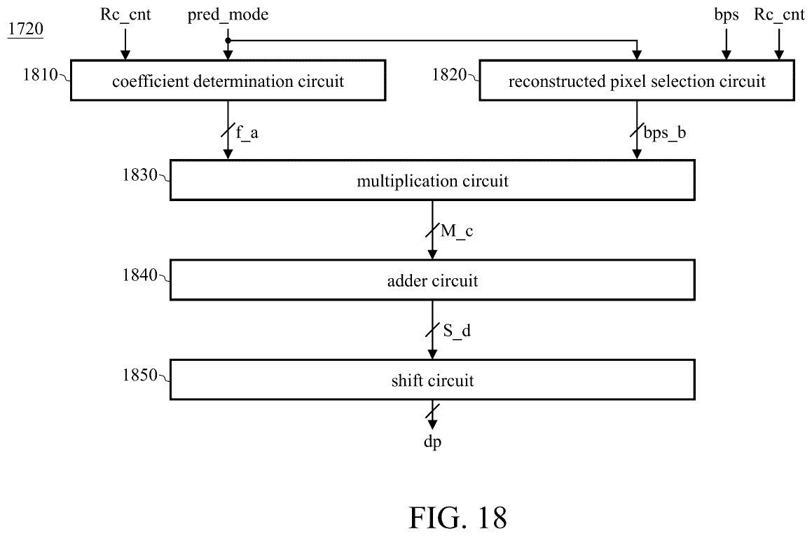

Reference is made to FIG. 18, which is a functional block diagram of the angle mode prediction circuit 1720 according to an embodiment of the present invention. The angle mode prediction circuit 1720 includes a coefficient determination circuit 1810, a reconstructed pixel selection circuit 1820, a multiplication circuit 1830, an adder circuit 1840, and a shift circuit 1850, all of which are coupled to each other. The coefficient determination circuit 1810, the reconstructed pixel selection circuit 1820, the multiplication circuit 1830, the adder circuit 1840, and the shift circuit 1850 are similar to the coefficient determination circuit 1610, the reconstructed pixel selection circuit 1620, the multiplication circuit 1630, the adder circuit 1640, and the shift circuit 1650, respectively. However, the coefficient determination circuit 1810 and the reconstructed pixel selection circuit 1820 further select the coefficients f_a and the reconstructed pixels bps_b based on the count value Rc_cnt.

People having ordinary skill in the art can understand the operational details of the angle mode prediction circuit 1720 based on the description of FIG. 16, so further elaboration is omitted for brevity.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A preliminary intra-prediction mode determination method for video coding, executed in a prediction circuit and used for determining a preliminary prediction mode of a to-be-predicted block, the preliminary intra-prediction mode determination method comprising:
calculating a first prediction angle of the to-be-predicted block;
determining whether the to-be-predicted block is a noise block; and
executing a non-angle mode decision when the to-be-predicted block is the noise block, or when the to-be-predicted block is not the noise block and the first prediction angle is not greater than a preset angle;
wherein the non-angle mode decision determines the preliminary prediction mode according to whether the to-be-predicted block is the noise block and a comparison result between the first prediction angle and the preset angle.

2. The method of claim 1 further comprising:
calculating a second prediction angle of the to-be-predicted block;
obtaining a determination result by determining whether the first prediction angle and the second prediction angle differ by 90 degrees, and whether a second intensity corresponding to the second prediction angle is greater than n times a first intensity corresponding to the first prediction angle when the to-be-predicted block is not the noise block, and the first prediction angle is greater than the preset angle, where n is greater than 0 and less than 1; and
executing an angle mode decision when the determination result is negative;
wherein the angle mode decision is to determine a prediction angle of the preliminary prediction mode.

3. The method of claim 2, wherein the first intensity is greater than the second intensity.

4. The method of claim 3, wherein the angle mode decision comprises following steps:
constructing a parallelogram based on the first prediction angle, the first intensity, the second prediction angle, and the second intensity, and using a diagonal of the parallelogram as a target angle; and
finding an angle closest to the target angle as a result prediction angle of the preliminary prediction mode according to a video coding mode.

5. The method of claim 2 further comprising:
executing the non-angle mode decision when the determination result is positive.

6. The method of claim 1, wherein when the method is operated in an Alliance for Open Media Video 1 (AV1) mode, the non-angle mode decision comprises following steps:
determining whether the to-be-predicted block is the noise block, or comparing the first prediction angle with the preset angle to obtain a first determination result;
determining that the preliminary prediction mode is the “Smooth_hv” mode when the first determination result indicates that the to-be-predicted block is the noise block or that the first prediction angle is less than the preset angle;
determining whether the first prediction angle is 90 degrees to obtain a second determination result when the first determination result is negative;
determining that the preliminary prediction mode is the “Smooth_v” mode when the second determination result is positive;
determining whether the first prediction angle is 180 degrees to obtain a third determination result when the second determination result is negative;
determining that the preliminary prediction mode is the “Smooth_h” mode when the third determination result is positive; and
determining that the preliminary prediction mode is the “paeth” mode when the third determination result is negative.

7. The method of claim 1, wherein when the method is operated in an MPEG-4 Part 10 Advanced Video Coding (H.264) mode and a High Efficiency Video Coding (H.265) mode, the non-angle mode decision comprises following steps:
determining that the preliminary prediction mode is a first mode when the to-be-predicted block is the noise block;
wherein for the H.265 mode, the first mode is the “DC” mode, and for the H.264 mode, the first mode is the “mean” mode.

8. The method of claim 7, wherein when the method is operated in the H.265 mode and the H.264 mode, the non-angle mode decision further comprises following steps:
determining that the preliminary prediction mode is the first mode when the to-be-predicted block is not the noise block, and the first prediction angle is not greater than the preset angle; or
determining that the preliminary prediction mode is a second mode when the to-be-predicted block is not the noise block, and the first prediction angle is greater than the preset angle;
wherein for the H.265 mode, the second mode is the “Planar” mode, and for the H.264 mode, the second mode is the “Mode 3” mode.

9. The method of claim 1, wherein the step of calculating the first prediction angle of the to-be-predicted block comprises:
calculating intensities of R angles for each pixel of the to-be-predicted block, where R is an integer greater than or equal to 2;
accumulating the intensities of the R angles for the to-be-predicted block; and
selecting an angle with the greatest intensity as the first prediction angle.

10. An intra-prediction circuit configured to perform an intra-prediction operation on a to-be-predicted block to generate an intra-prediction image, the intra-prediction circuit comprising:
an MPEG-4 Part 10 Advanced Video Coding (H.264) mode control circuit configured to output a plurality of reconstructed pixels and a preliminary prediction mode corresponding to the to-be-predicted block according to a start signal of the to-be-predicted block;
a shared control circuit coupled to the H.264 mode control circuit and configured to output the plurality of reconstructed pixels and the preliminary prediction mode corresponding to the to-be-predicted block according to the start signal; and
at least one prediction circuit coupled to the H.264 mode control circuit and the shared control circuit and configured to generate a plurality of predicted values based on the plurality of reconstructed pixels, and determine a part of the intra-prediction image from the plurality of predicted values according to the preliminary prediction mode;
wherein the start signal of the to-be-predicted block indicates the start of the to-be-predicted block.

11. The intra-prediction circuit of claim 10, wherein the shared control circuit, in response to a macro block start signal, provides the plurality of reconstructed pixels and the preliminary prediction mode corresponding to the to-be-predicted block of 16 pixels by 16 pixels to the H.264 mode control circuit.

12. The intra-prediction circuit of claim 10, wherein the shared control circuit manages the plurality of reconstructed pixels and the preliminary prediction mode corresponding to the to-be-predicted block of 32 pixels by 32 pixels and 16 pixels by 16 pixels in an H.264 mode, a High Efficiency Video Coding (H.265) mode, and an Alliance for Open Media Video 1 (AV1) mode, and manages the plurality of reconstructed pixels and the preliminary prediction mode corresponding to the to-be-predicted block of 8 pixels by 8 pixels and 4 pixels by 4 pixels in the H.265 mode and the AV1 mode, while the H.264 mode control circuit manages the plurality of reconstructed pixels and the preliminary prediction mode corresponding to the to-be-predicted block of 8 pixels by 8 pixels and 4 pixels by 4 pixels in the H.264 mode.

13. The intra-prediction circuit of claim 10, wherein the intra-prediction circuit is coupled to a mode determination circuit, and after the mode determination circuit generates the plurality of reconstructed pixels of the to-be-predicted block, the shared control circuit stores luminance values and chrominance values of the plurality of reconstructed pixels at the rightmost column, and stores the luminance values and the chrominance values of the plurality of reconstructed pixels at the bottommost row.

14. The intra-prediction circuit of claim 10, wherein the start signal is a first start signal, the plurality of reconstructed pixels are a plurality of first reconstructed pixels, the intra-prediction circuit is coupled to a mode determination circuit, the mode determination circuit sequentially processes a first to-be-predicted block and a second to-be-predicted block, the shared control circuit stores a bottom-right reconstructed pixel from a plurality of second reconstructed pixels of the first to-be-predicted block according to a second start signal of the second to-be-predicted block, and the second start signal indicates the start of the second to-be-predicted block.

15. The intra-prediction circuit of claim 14, wherein the size of the first to-be-predicted block and the size of the second to-be-predicted block are 8 pixels by 8 pixels.

16. The intra-prediction circuit of claim 10, wherein the intra-prediction circuit is coupled to a mode determination circuit, and when the mode determination circuit determines a block coding method of the to-be-predicted block, the mode determination circuit generates an end signal, and the shared control circuit stores a bottom-right reconstructed pixel from the plurality of reconstructed pixels of the to-be-predicted block according to the end signal.

17. The intra-prediction circuit of claim 10, wherein the at least one prediction circuit comprises:
an angle mode prediction circuit configured to generate a first predicted value based on the preliminary prediction mode and the plurality of reconstructed pixels;
a reconstructed pixel processing circuit configured to process the plurality of reconstructed pixels to generate a second predicted value, a third predicted value, and a fourth predicted value;
a Planar mode calculation circuit configured to perform calculations on the plurality of reconstructed pixels to obtain a fifth predicted value; and
a multiplexer coupled to the angle mode prediction circuit, the reconstructed pixel processing circuit, and the Planar mode calculation circuit, and configured to select one of the first predicted value, the second predicted value, the third predicted value, the fourth predicted value, and the fifth predicted value as the part of the intra-prediction image according to the preliminary prediction mode.

18. The intra-prediction circuit of claim 17, wherein the at least one prediction circuit further comprises:
a control circuit configured to generate a count value according to a control signal, wherein the control signal indicates the start of a to-be-predicted block of 4 pixels by 4 pixels, and the count value indicates at least one of a column number and a row number of the to-be-predicted block of 4 pixels by 4 pixels that the at least one prediction circuit is processing;
wherein the angle mode prediction circuit, the reconstructed pixel processing circuit, and the Planar mode calculation circuit further generate the first predicted value, the second predicted value, the third predicted value, the fourth predicted value, and the fifth predicted value based on the count value.

19. The intra-prediction circuit of claim 17, wherein the angle mode prediction circuit comprises:
a coefficient determination circuit configured to determine a plurality of coefficients according to the preliminary prediction mode;
a reconstructed pixel selection circuit configured to determine a plurality of target reconstructed pixels from the plurality of reconstructed pixels according to the preliminary prediction mode;
a multiplication circuit coupled to the coefficient determination circuit and the reconstructed pixel selection circuit and configured to multiply the plurality of coefficients and the plurality of target reconstructed pixels to obtain a plurality of products;
an adder circuit coupled to the multiplication circuit and configured to add the plurality of products to obtain a plurality of sums; and
a shift circuit coupled to the adder circuit and configured to shift the plurality of sums to generate the first predicted value.

20. The intra-prediction circuit of claim 10, wherein the at least one prediction circuit comprises:
a control circuit configured to generate a count value according to a control signal, wherein the control signal indicates the start of a to-be-predicted block of 4 pixels by 4 pixels, and the count value indicates a column number and/or a row number of a target to-be-predicted block that the at least one prediction circuit is processing;
a reconstructed pixel processing circuit configured to process the plurality of reconstructed pixels to generate a first predicted value, a second predicted value, and a third predicted value;
a Planar mode calculation circuit configured to perform calculations on the plurality of reconstructed pixels to obtain a fourth predicted value; and
a multiplexer coupled to the reconstructed pixel processing circuit and the Planar mode calculation circuit and configured to select one of the first predicted value, the second predicted value, the third predicted value, and the fourth predicted value as the part of the intra-prediction image according to the preliminary prediction mode.
